(19) United States
(12) Patent Application Publication
(10) Pub. No.: US 2011/0249528 A1
(43) Pub. Date: Oct. 13, 2011

(54) MIXER ASSEMBLY

(75) Inventors: Katrin Wand, Schonenberg/schwartz (DE); Jürgen Mökander, Sollentuna (SE); Rolf Lindeborg, Jarfalla (SE); Jörgen Engström, Grodinge (SE); Tanja Hedberg, Stockholm (SE); Thomas Bartholf, Nacka (SE)

(73) Assignee: ITT Manufacturing Enterprises, Inc., Wilmington, DE (US)

(21) Appl. No.: 13/125,094

(22) PCT Filed: Oct. 22, 2009
(86) PCT No.: PCT/SE2009/051206

§ 371 Date: Jun. 20, 2011

(30) Foreign Application Priority Data
Oct. 23, 2008 (SE) 0850051-4

(51) Int. Cl. H02K 21/46; B01F 7/22

(52) U.S. Cl. 366/251; 310/156.78

(57) ABSTRACT

A mixer assembly for generating and maintaining a motion within a volume of liquid, the mixer assembly including a motor, a drive shaft and a propeller connected to the drive shaft. When the propeller is in operation, it is driven by the motor and rotates about a propeller axis. The mixer assembly's motor comprises a stator and a hybrid type rotor. The hybrid rotor includes a rotor core comprising an annular radially outer section of asynchronous type and an annular radially inner section of synchronous type arranged radially inside the annular radially outer section.

### CROSS REFERENCE TO RELATED APPLICATIONS

This application is the U.S. national phase application of PCT International Application No. PCT/SE2009/051206, filed Oct. 22, 2009, which claims priority to Swedish Patent Application No. 0850051-4, filed Oct. 23, 2008, the contents of such applications being incorporated by reference herein.

### FIELD OF THE INVENTION

The present invention relates generally to the field of devices arranged to be submersed into a liquid and operable for stirring the liquid by means of a propeller, which is driven in rotation. Further, the present invention relates specifically to the field of mixer assemblies for generating and maintaining a motion within a volume of liquid, e.g. waste water. The mixer assembly comprises a motor, a propeller and an intermediate drive shaft connected to said motor and propeller, the propeller in operation being driven by the motor for rotation about a propeller axis in order to generate a liquid flow from a suction side to a pressure side of the propeller.

### BACKGROUND OF THE INVENTION

The mixers referred to are used mainly to generate and maintain a motion within a volume of liquid, in order to prevent sedimentation or agglomeration of solid matter that is dispersed in the liquid, or for de-stratification of liquids having different densities, for homogenization or for the mixing of substances in liquid, etc. Typical implementations include waste water treatment, water purification, PH-neutralization, chlorine treatment processes, cooling applications, de-icing applications, manure treatment processes, for example. Thus, mixers are conventionally used in applications in which they are in constant operation for long periods of time, e.g. days or weeks or even longer.

A prior art mixer comprises an asynchronous motor powered directly from the power mains having a frequency of e.g. 50-60 Hz. Thereto, for many applications it is suitable to have the propeller of the mixer to rotate at about 500-600 rpm, this entails that the number of poles of the asynchronous motor in such an application is chosen to be twelve. However, an asynchronous motor having a large number of poles has a low power factor, because a big stator current component is needed to magnetize the machine. The increased stator current also lead to increased stator current losses and decreased motor efficiency.

The magnetizing current component of the stator current increases as the number of poles of the motor increases. The efficiency of a comparable prior art mixer comprising an asynchronous motor having a large number of poles is usually quite low for a given power output.

There are different ways of increasing the efficiency by means of design changes. However, the most cost efficient way of increasing the efficiency of an asynchronous motor of a specific mixer, for a given power output, is to use a larger motor. However, this entails that a larger stator housing is required which de facto results in that a new mixer is obtained, and not an improved mixer in respect of increased efficiency for a given power output for a specific mixer. However, the increase in efficiency of an asynchronous motor of a specific mixer is not justifiable in relation to the increase in manufacturing cost.

### SUMMARY OF THE INVENTION

The present invention aims at obviating the aforementioned disadvantages of previously known mixers, and at providing an improved mixer assembly. An object of the present invention is to provide an improved mixer assembly of the initially defined type which may comprise an unchanged stator and at the same time increase the power factor as well as the efficiency of the mixer assembly for a given power output.

According to aspects of the invention at least one objective is attained by means of the mixer assembly described herein.

According to a first aspect of the present invention, there is provided a mixer assembly wherein the motor comprises a stator and a rotor of hybrid type, the rotor of hybrid type comprising a rotor core comprising an annular radially outer section of asynchronous type and an annular radially inner section of synchronous type arranged radially inside said outer section.

Thus, the present invention is based on the insight that the use of an inventive hybrid rotor result in that the advantage of a synchronous motor may be utilized, i.e. a higher power factor with a large number of poles and a higher efficiency due to decreased rotor losses for a given power output.

In a preferred embodiment of the present invention, the annular radially outer section of the rotor core of the rotor of hybrid type comprises a number of rotor slots arranged therein filled with a non-magnetic and electric conducting material, which rotor slots are axially arranged adjacent and distributed along an envelope surface of said rotor core. This means that at startup of the mixer the motor will operate as an asynchronous motor. That is, the stator current creates rotating magnetic fields which induces currents in the rotor slots, the induced currents creating magnetic fields which tries to catch up with the rotating magnetic fields of the stator.

In a preferred embodiment of the present invention, the annular radially inner section of the rotor core of the rotor of hybrid type comprises a number of permanent magnets. This means that when the hybrid rotor has been provided a rotating motion, the permanent magnets will take over from the rotor slots which results in the hybrid rotor will catch up and rotate synchronous with the rotating magnetic field of the stator, and the rotor slots will be inactive. Thus, after start up of the mixer, and during normal operation, the motor will operate as a synchronous motor. The efficiency of a permanent magnet motor is much higher due to reduced rotor losses, i.e. there is not any current in a rotor at synchronous speed and thus there are not any rotor current losses like in asynchronous motors. In the case with a large number of poles, the magnetizing current component of the stator current is also reduced, which lead to a higher power factor and thus decreased stator current losses.

According to a preferred embodiment, the annular radially inner section of the rotor core comprises a number of axially arranged V-shaped slots, which are oriented to be open radially outwards, each of the two outer ends of the V-shaped slot being ended adjacent and radially inside a rotor slot of the annular radially outer section of the rotor core, and being separated from said rotor slot by a material bridge of the rotor core. Preferably said material bridge is in the range 0.5-2 millimeters. Thereby the material bridge is too narrow for the magnetic field to leak there through and the material bridge will be saturated which further prevents the magnetic field to short cut from one pole to a neighboring pole.

### BRIEF DESCRIPTION OF THE DRAWINGS

The invention is best understood from the following detailed description when read in connection with the accompanying drawings. Included in the drawings is the following figures:

FIG. 1 is a side view of a mixer assembly,

FIG. 2 is a schematic side view of a drive shaft unit comprising a hybrid rotor partly in cross section,

FIG. 3 is a schematic perspective view of a stator and a hybrid rotor partly in cross section,

FIG. 4 is a schematic view from above of a rotor core,

FIG. 5 is a schematic view from above of the shaft unit according to FIG. 2,

FIG. 6 is an enlarged view from above of a part of an alternative embodiment of the rotor core, and

FIG. 7 is an enlarged view from above of a part of another alternative embodiment of the rotor core.

### DETAILED DESCRIPTION OF PREFERRED EMBODIMENTS

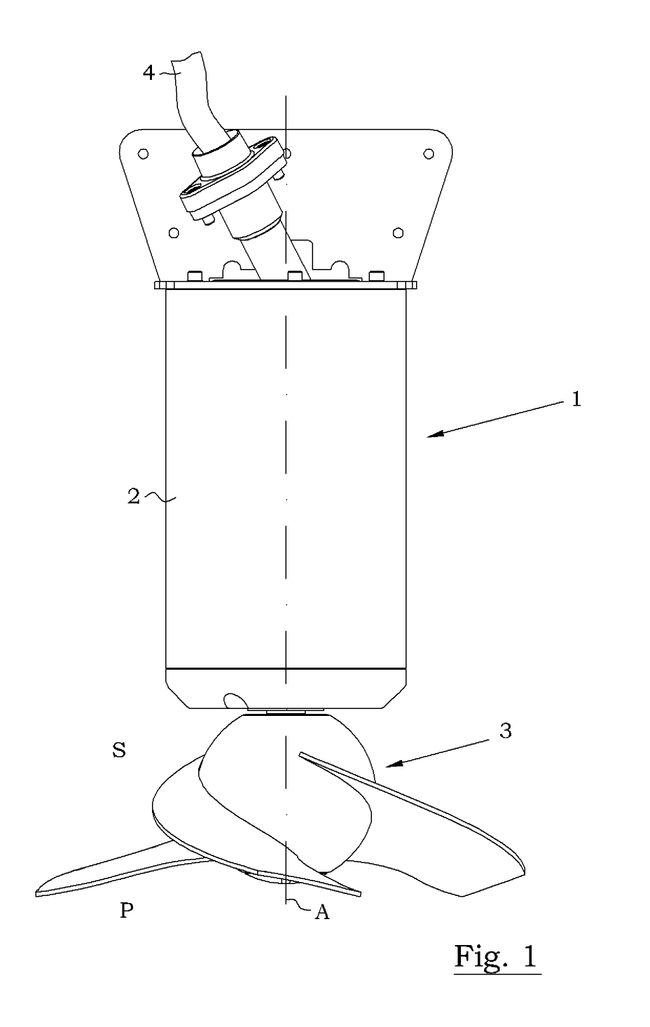

In FIG. 1 is shown a mixer 1, or mixer assembly. The mixer 1 comprises a housing 2, also known as stator housing, and a propeller 3 having a suction side S and a pressure side P. An electric cable 4 extends from the mixer 1 and is arranged to be connected directly to the power mains, i.e. the mixer 1 does not need any variable frequency drive (VFD) or the like to ramp up the stator current at the start of the mixer 1. Such a mixer 1 is also known as a line started mixer.

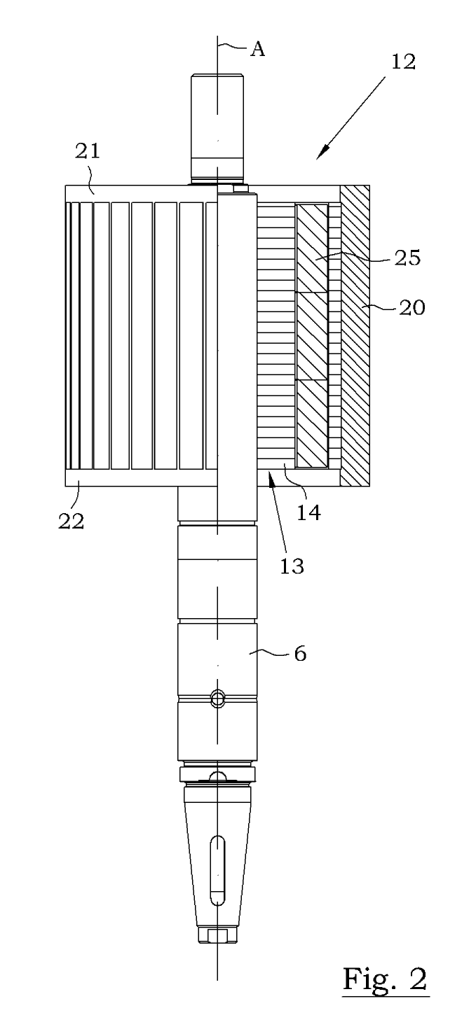

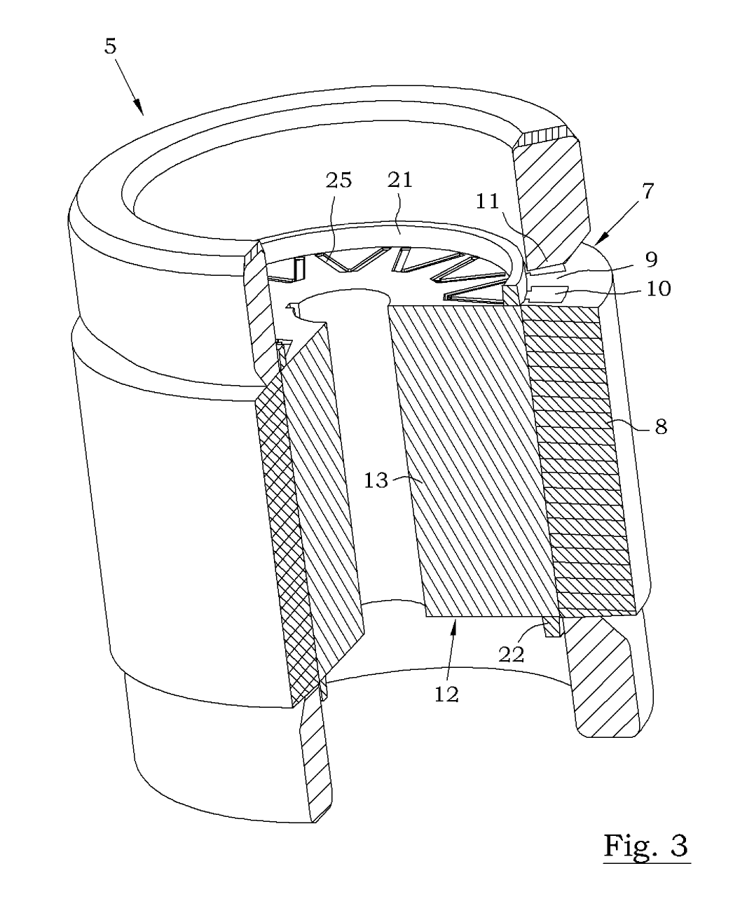

Reference is now made to FIGS. 2 and 3. The mixer 1 comprises a motor, generally designated 5, and a drive shaft 6 extending from said motor 5 to the propeller 3 of the mixer 1, i.e. the propeller 3 is fitted to the lower end of the drive shaft 6. The propeller 3 in operation is driven by the motor 5 for rotation about a propeller axis A in order to generate a liquid flow from the suction side S to the pressure side P of the propeller 3. The propeller 3 comprises a hub and one or more vanes extending from said hub.

The motor 5 comprises a stator 7, which preferably is the same as is used in the comparable prior art mixer, i.e. the inventive mixer assembly 1 comprises the same stator 7 as the prior art mixer that comprises a fully asynchronous motor. However, it should be pointed out that a synchronous stator and an asynchronous stator are equivalents regarding to the inventive mixer assembly 1. The stator 7, in the shown embodiment, comprises a number of annular stator plates 8 stacked onto each other, which are made of a magnetic material, e.g. metal such as iron. The stack of stator plates 8 comprises a number of axially extending teeth 9, which are protruding inwards and which are separated by stator slots 10. Stator coiling 11, which is schematically shown in FIG. 3, is arranged in the stator slots 10 in a conventional way, such that magnetic fields will rotate along the stator 7 about the propeller axis A when the mixer 1, i.e. the stator coiling 11, is connected to the power mains. The stator coiling 11 may be constituted by distributed winding or concentrated winding, i.e. overlapping windings or single tooth windings, respectively.

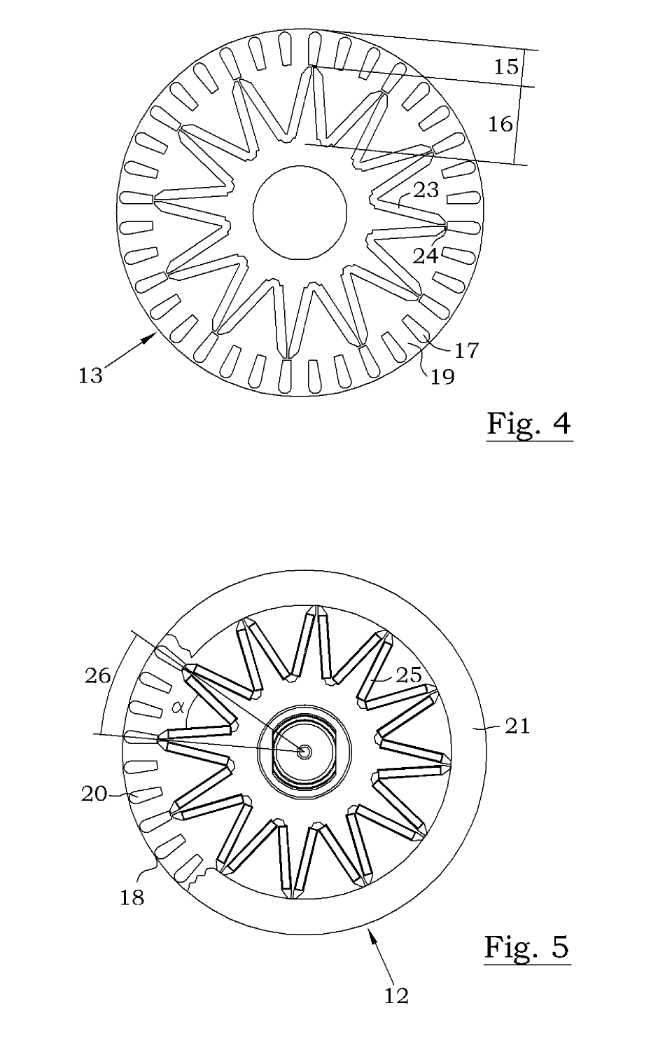

Reference is now also made to FIGS. 4 and 5. In addition to the stator 7 the motor 5 comprises a hybrid rotor, generally designated 12. The hybrid rotor 12 comprises a rotor core 13, which may be a stack of several rotor plates 14, as disclosed in Hg. 2, or which may be cast in one piece, as disclosed in FIG. 3. The rotor core 13 is made of a magnetic material, e.g. metal such as iron. It is essential that the rotor core 13 comprises an annular radially outer section 15 of asynchronous type and an annular radially inner section 16 of synchronous type arranged radially inside said outer section, see FIG. 4 in which the width of each annular section is indicated. The annular outer section 15 of asynchronous type is arranged to be active only at startup of the motor 5 and the annular inner section 16 of synchronous type is arranged to be positively active after the hybrid rotor 12 has obtained a rotating motion and during normal operation.

According to a preferred embodiment of the invention, the annular radially outer section 15 of the rotor core 13 of the hybrid rotor 12 comprises a number of rotor slots 17 arranged therein. In the preferred embodiment, shown in FIGS. 4 and 5, each rotor slot 17 is delimited by a straight base wall from which two side walls are diverging outwards, said side walls being connected by a semi-circular top wall. The rotor slots 17 are axially arranged adjacent and distributed along an envelope surface of said rotor core 13. Upon manufacturing of the rotor core 13, each rotor slot 17 is preferably fully delimited by the rotor core 13, in order to facilitate the manufacturing of the rotor core 13, e.g. by means of punching of the rotor plates 14. The finished hybrid rotor 12 comprises a material bridge 18, arranged between the radially most outer part of the rotor slot 17 and the envelope surface of the rotor core 13, which material bridge 18 preferably is within the range 0-2 millimeters in the radial direction. The final width of said material bridge 18 is achieved by means of machining, e.g. turning of the hybrid rotor 12, which machining also is made to balance the hybrid rotor. Thus, during normal operating of the mixer 1 when a material bridge is lacking or a thin material bridge 18 exists between the radially outer most part of the rotor slot 17 and the envelope surface of the rotor core 13, the magnetic field will be prevented from leaking. Either due to the lack of a material bridge of due to the fact that a thin material bridge will be saturated, which prevents the magnetic field from leaking. The rotor slots 17 are separated by rotor teeth 19, connecting the annular inner section 16 with the envelope surface of the rotor core 13. Due to the preferred shape of the rotor slots 17, from a manufacturing point of view, the width of the major part of the each rotor tooth 19 is uniform, see FIG. 3. Thus, the adjacent side walls of two neighboring rotor slots 17 are preferably parallel with each other.

The rotor slots 17 are filled with rotor slot fillings 20, see FIGS. 2 and 5, made of a non-magnetic material, e.g. aluminum or cupper, in which an electric current may be induced. In the upper and lower ends of the hybrid rotor 12, the rotor slot fillings 20 are joined by means of an upper ring 21 and a lower ring 22, of the same material as the rotor slot fillings 20. The upper ring 21, the lower ring 22 and the rotor slot fillings 20 are jointly also known as a rotor cage. The rotor cage may be cast in one piece, or the rotor slot fillings 20 may be pre-cast bars, which are inserted into the rotor slots 17 and joined by the upper ring 21 and the lower ring 22, respectively.

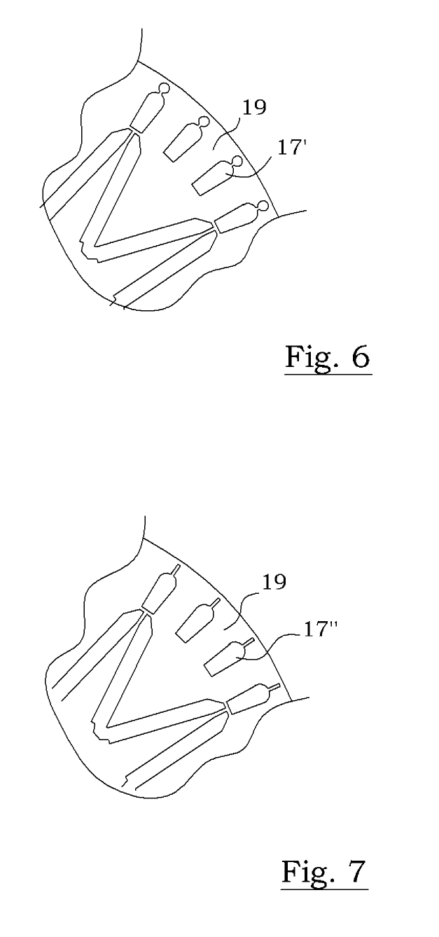

Reference is now made to FIGS. 6 and 7, which discloses example of alternative embodiments of rotor slots. The rotor slots 17′ according to FIG. 6 comprises an extension in the shape of a circular top placed on top of the rotor slot 17 according to the preferred embodiment, and the rotor slots 17″ according to FIG. 7 comprises an extension in the shape of a bottle neck placed on top of the rotor slot 17 according to the preferred embodiment. The shown alternative embodiments, as well as their equivalents, are fully exchangeable with the preferred embodiment according to FIG. 4.

According to a preferred embodiment of the invention the annular radially inner section 16 of the rotor core 13 of the hybrid rotor 12 comprises a number of V-shaped slots 23 arranged therein, see FIG. 4. Said V-shaped slots may be constituted by two separate straight slots arranged in a V and separated only by means of a thin material bridge. The V-shaped slots 23 are axially arranged in the rotor core 13 and are oriented to be open radially outwards. Each of the outer end of the two legs of the V-shaped slot 23 is ended adjacent and radially inside a rotor slot 17 of the annular radially outer section 15 of the rotor core 13, and is separated from said rotor slot 17 by a material bridge 24 of the rotor core 13. In the shown embodiment, two adjacent legs of two neighboring V-shaped slots 23 are ended radially inside the same rotor slot 17.

In the preferred embodiment of the hybrid rotor 12, the annular radially inner section 16 of the rotor core 13 of the hybrid rotor 12 comprises a number of permanent magnets 25, which are inserted into said V-shaped slots 23 such that each V-shaped slot 23 constitute a pole 26 of the hybrid rotor 12. The permanent magnets 25 are cuboids, and in the preferred embodiment two, three or more axially arranged permanent magnets 25 are inserted into each leg of the V-shaped slot 26. The use of several permanent magnets 25 in each leg of the V-shaped slot 26 comes from the difficulty to make long, thin and wide permanent magnets 25. It should be pointed out that the base of the V-shaped slots 23 as well as the outer ends of each leg of the V-shaped slots 23 is filled with air, or any other suitable gas. Every second pole 26 is “positive” and every other pole 26 is “negative.” In the shown embodiment the hybrid rotor 12 comprises twelve poles 26, this result in that during normal operation of the mixer 1, the hybrid rotor 12 and thus the propeller 3 will rotate at 500-600 rpm when powered directly from the power mains having a frequency of 50-60 Hz. It should be pointed out that when power from a power mains having another frequency the propeller 3 will rotate at a different speed.

The material bridge 24 between each of the outer ends of the V-shaped slot 23 and the nearest rotor slot 17 is preferably in the range 0.5-2 millimeters. The material bridge 24 should be as narrow as possible to avoid leakage of magnetic flux and at the same time as big as possible to hold the rotor core 13 together. For the given range the material bridge 24 is narrow enough to avoid a high leakage of magnetic flux and the material bridge 24 will be saturated which further prevents the magnetic flux to short cut from one pole 26 to a neighboring pole 26. It is important that the magnetic field of each pole 26 is radially directed towards the envelope surface of the hybrid rotor 12.

In theory, it is important for the proper functioning of the inventive hybrid rotor 12 that, the permanent magnets 25 are arranged as near the center of the hybrid rotor 12 as possible upon start up of the motor 5 since they will have a negative effect on the start performances of the motor 5, and arranged as near the envelope surface of the hybrid rotor 12 as possible during normal operation of the mixer 1. Thus, the permanent magnets 25 should be located as near as possible the envelope surface of the hybrid rotor 12 without obstructing the start up of the motor 5. According to a preferred embodiment of the inventive hybrid rotor 12 the radially outer end of the permanent magnets 25 are located at a distance from the centre of the hybrid rotor 12 which is less than 80% of the radius of the hybrid rotor 12.

The total permanent magnet area per pole 26, seen in a cross sectional view in accordance with FIG. 5, is in the range 100-300 square millimeters, and the permanent magnets are of Neodymium Iron Boron (NdFeB) type, in order to achieve a proper functioning of the motor 5 during normal operation of the motor 5 without obstructing the start up of the motor 5. Preferably the total permanent magnet area per pole 26 shall be above 200 square millimeters, more preferably above 240 square millimeters, and preferably below 250 square millimeters. Preferably the angel a between the legs of the V-shaped slot 23, and thus between the permanent magnets 25 in one pole 26, is in the range 36-80°. Preferably said angle a shall be above 40° and preferably below 50°, in order to obtain a more or less radially directed magnetic field at the envelope surface of the hybrid rotor 12.

The permanent magnets shall preferably be temperature resistant to at least 150° C., in order to withstand the process temperature during an impregnation of the rotor, which impregnation is performed in order to protect the permanent magnets against hydrogen gas. Hydrogen gas can be present in some applications and the hydrogen gas will start a degradation process of the permanent magnets if they are not protected by means of an impregnation, or the like.

The total rotor slot area per pole 26, seen in a cross sectional view according to FIG. 4, is in the range 200-350 square millimeters, in order to achieve a proper functioning of the motor 5 during start up of the motor 5 without obstructing the normal operation of the motor 5. Preferably the total rotor slot area per pole 26 shall be above 250 square millimeters, more preferably above 270 square millimeters, and preferably below 300 square millimeters, more preferably below 280 square millimeters. Preferably, the number of rotor slots 17 per pole 26 is in the range 3-7. The number of rotor slots 17 and the total rotor slot are per pole 26 effects the ability for the stator 7 to induce currents in the rotor slot fillings 20 upon start up of the motor 5, which induced currents are strong enough to generate magnetic fields strong enough to follow the rotating magnet field of the stator 7. Thus, the rotor slots 17, i.e. the annular radially outer section 15, are used to get the hybrid rotor 12 to start to rotate asynchronously with the supplied power. Thereafter, the permanent magnets 25, i.e. the annular radially inner section 16, gets the hybrid rotor 12 to rotate synchronously with the supplied power.

Preferably the total width of the rotor teeth 19 per pole 26, in the circumferential direction, is less than 2.5 times the total width of the rotor slots 17 per pole 26, in the circumferential direction.

According to aspects of the invention the efficiency of an inventive mixer assembly 1, according to the figures, comprising the same stator 7 as a comparable prior art mixer and a hybrid rotor 12 having twelve poles is about 10 percentage units better than the comparable mixer having a fully asynchronous motor for a given power output. This will lead to a much lower energy cost per year and it is also possible to take more power out of the improved mixer assembly 1. As an example it is possible to take out over 9 kW from the mixer assembly 1 comprising a hybrid rotor 12, in relation to the maximum 5.5 kW power output for the same mixer comprising a fully asynchronous motor.

The invention is not limited only to the embodiments described above and shown in the drawings, which primarily have an illustrative and exemplifying purpose. This patent application is intended to cover all adjustments and variants of the preferred embodiments described herein, thus the present invention is defined by the wording of the appended claims and the equivalents thereof. Thus, the mixer assembly may be modified in all kinds of ways within the scope of the appended claims.

It shall be pointed out that mixer and mixer assembly are used as exchangeable expressions.

It shall also be pointed out that all information about/concerning terms such as above, below, under, upper, etc., shall be interpreted/read having the equipment oriented according to the figures, having the drawings oriented such that the references can be properly read. Thus, such terms only indicates mutual relations in the shown embodiments, which relations may be changed if the inventive equipment is provided with another structure/design. In addition, it shall be pointed out that the figures are not drawn according to scale.

It shall also be pointed out that even thus it is not explicitly stated that features from a specific embodiment may be combined with features from another embodiment, the combination shall be considered obvious, if the combination is possible.

Throughout this specification and the claims which follows, unless the context requires otherwise, the word “comprise”, and variations such as “comprises” or “comprising”, will be understood to imply the inclusion of a stated integer or steps or group of integers or steps but not the exclusion of any other integer or step or group of integers or steps.

1.-12. (canceled)

13. A mixer assembly for generating and maintaining a motion within a volume of liquid, the mixer assembly comprising a motor, a drive shaft and a propeller connected to the drive shaft, the propeller in operation being driven by the motor for rotation about a propeller axis, wherein said motor comprises a stator and a hybrid rotor, the hybrid rotor comprising a rotor core comprising an annular radially outer section of asynchronous type and an annular radially inner section of synchronous type arranged radially inside said outer section.

14. A mixer assembly according to claim 13, wherein the annular radially outer section of the rotor core of the hybrid rotor comprises a plurality of rotor slots arranged therein filled with a non-magnetic and electric conducting material, which rotor slots are axially arranged adjacent and distributed along an envelope surface of said rotor core.

15. The mixer assembly according to claim 13, wherein the annular radially inner section of the rotor core of the hybrid rotor comprises a number of permanent magnets.

16. The mixer assembly according to claim 13, wherein the annular radially inner section of the rotor core comprises a number of axially arranged V-shaped slots with two legs, which are oriented to be open radially outwards, each of an outer end of the two legs of the V-shaped slot being ended adjacent and radially inside a rotor slot of the annular radially outer section of the rotor core, and being separated from said rotor slot by a material bridge of the rotor core.

17. The mixer assembly according to claim 16, wherein a width of the material bridge between each of the outer end of the two legs of the V-shaped slot and the nearest rotor slot is in the range 0.5-2 millimeters in the radial direction.

18. The mixer assembly according to claim 16, wherein permanent magnets are inserted into the V-shaped slots such that each V-shaped slot constitutes one pole of the hybrid rotor.

19. The mixer assembly according to claim 18, wherein a total permanent magnet area per pole is in the range of 100-300 square millimeters, and the permanent magnets are of Neodymium Iron Boron (NdFeB) type.

20. The mixer assembly according to claim 18, wherein a total rotor slot area per pole is in the range of 200-350 square millimeters.

21. The mixer assembly according to claim 18, wherein the number of rotor slots per pole is in the range of 3-7.

22. The mixer assembly according to claim 16, wherein an angle between the legs of the V-shaped slot is in the range of 36-80°.

23. The mixer assembly according to claim 15, wherein a radially outer end of the permanent magnets are located at a distance from the centre of the hybrid rotor, which is less than 80% of the radius of the hybrid rotor.

24. The mixer assembly according to claim 18 wherein a number of poles of the hybrid rotor is twelve.
